(19) United States
(12) Patent Application Publication
(10) Pub. No.: US 2015/0102276 A1
(43) Pub. Date: Apr. 16, 2015

(54) LIFTING SUPPORT FRAME

(71) Applicant: NANTONG JINYUE GARMENT DESIGN CO., LTD., Nantong (CN)

(72) Inventor: Deng Juanjuan, Nantong (CN)

(73) Assignee: NANTONG JINYUE GARMENT DESIGN CO., LTD., Nantong (CN)

(21) Appl. No.: 14/052,853

(22) Filed: Oct. 14, 2013

(51) Int. Cl. B66F 3/24; B66F 3/25

(52) U.S. Cl. CPC B66F 3/24; B66F 3/25
USPC 254/93 R

(57) ABSTRACT

This invention discloses a lifting support frame, comprising a frame, a fixed seat, a hydraulic cylinder, a guide spindle, a guide plate and a support plate. In the frame the fixed seat is fixedly connected, at both sides of the fixed seat, a hydraulic cylinder is connected, and in the middle of the fixed plate, the guide spindle is connected fixedly. Above the said hydraulic cylinder and guide spindle, a horizontal guide plate is fixedly connected, where a support plate is provided. This invention solves the problem existing in the techniques, and is featured with high efficiency and low cost.

### TECHNICAL FIELD

This invention is relating to a lifting structure, specifically to a lifting support frame.

### BACKGROUND OF TECHNOLOGY

In the working process of production lines in the existing light industry, manufacturing industry and textile industry, the material and semi-products are needed to be moved or shifted to other places as required. Normally manual handling or simple lifting structure is applied for the handling. The manual handling is a labor-consumable and material-consumable process with low efficiency, while the simple lifting structure used in the process is less stable, impacting the work efficiency.

### CONTENT OF THE INVENTION

The purpose of the invention: in order to achieve the above purpose, this invention provides a high efficiency, low cost lifting support frame.

The technical solution: in order to achieve the above purpose, this invention adopts the following technical solution:

A lifting support frame consists of the frame, fixed seat, hydraulic cylinder, guide spindle, guide plate and support plate. In the frame the fixed seat is firmly connected, at both sides of the fixed seat, a hydraulic cylinder is connected, and in the middle of the fixed seat, the guide spindle is connected fixedly. Above the said hydraulic cylinder and guide spindle, a horizontal guide plate is fixedly connected, where a support plate is provided on the guide plate.

A guide slider for the clearance fit to the guide spindle.

The upper part of the hydraulic cylinder and guide spindle are fixedly connected to the guide plate through hexagonal bolts.

The hydraulic cylinder stroke is controlled by the solenoid switch.

The frame is made up of the square tubes by welding.

The anti-sliding convex point is set on the support plate surface.

Beneficial effect: the lifting support frame during the production line process solves the problem that a workpiece requires rapid rising up and coming down when necessary. In addition, it provides high efficiency and low cost, as well as the simple operation, energy-saving and environmental protection, appropriate for the wide range of application in the industry.

### NOTES TO THE FIGURE

FIG. 1 is the sketch for the structure of the invention.

### THE SPECIFIC IMPLEMENTATION

### Specification

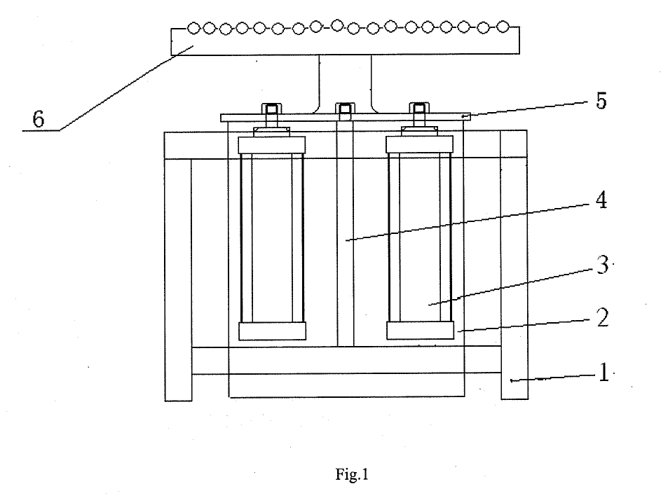

FIG. 1 shows a lifting support frame, including frame 1, fixed seat 2, hydraulic cylinder 3, guide spindle 4, guide plate 5 and support plate 6. In the frame 1, a fixed seat 2 is connected, at both sides of the fixed seat 2, a hydraulic cylinder 3 is connected respectively, in the middle of the fixed seat 2, a guide spindle 4 is firmly connected, above the hydraulic cylinder 3 and guide spindle 4, firmly connected is the horizontal guide plate 5, where a support plate 6 is connected.

A guide slider for clearance fit to the guide spindle 4 is provided, and the upper part of the hydraulic cylinder 3 and guide spindle 4 are fixedly connected to the guide plate 5 through hexagonal bolts. The stroke of the hydraulic cylinder 3 is controlled by the solenoid switch. The frame 1 is made up of the square tubes by welding. The anti-sliding convex point is set on the surface of the support plate 6.

1. A lifting support frame is characterized as: it includes the frame, fixed seat, hydraulic cylinder, guide spindle, guide plate and support plate. In the frame the fixed seat is firmly connected, at both sides of the fixed seat, a hydraulic cylinder is connected, and in the middle of the fixed seat, the guide spindle is connected fixedly. Above the said hydraulic cylinder and guide spindle, a horizontal guide plate is fixedly connected, where a support plate is provided on the guide plate.

2. According to the patent claim 1, the lifting support frame is featured with a guide slider for the clearance fit to the guide spindle.

3. According to the patent claim 1, the lifting support frame is featured with upper part of hydraulic cylinder and guide spindle is fixedly connected to the guide plate through hexagonal bolts.

4. According to the patent claim 1, the lifting support frame is featured with the hydraulic cylinder stroke controlled by the solenoid switch.

5. According to the patent claim 1, the lifting support frame is featured with the square tubes welded to form the frame.

6. According to the patent claim 1, the lifting support frame is featured with the anti-sliding convex point on the support plate surface.
